(19) United States
(12) Patent Application Publication
(10) Pub. No.: US 2022/0166045 A1
(43) Pub. Date: May 26, 2022

(54) REDOX FLOW BATTERY

(71) Applicant: MITSUBISHI HEAVY INDUSTRIES, LTD., Tokyo (JP)

(72) Inventors: Toshiyasu Kiyabu, Tokyo (JP); Yoshinori Noguchi, Tokyo (JP); Ikumi Watanabe, Tokyo (JP); Koichiro Hirayama, Tokyo (JP)

(73) Assignee: MITSUBISHI HEAVY INDUSTRIES, LTD., Tokyo (JP)

(21) Appl. No.: 17/441,518

(22) PCT Filed: Jan. 29, 2020
(86) PCT No.: PCT/JP2020/003179

§ 371 Date: Sep. 21, 2021

(30) Foreign Application Priority Data
Mar. 28, 2019 (JP) 2019-064618

(51) Int. Cl. H01M 8/18; H01M 8/04276

(52) U.S. Cl. CPC H01M 8/188; H01M 8/04276

(57) ABSTRACT

The present invention addresses the problem of providing a redox flow battery that can be used more efficiently and for an extended period of time. This redox flow battery includes a cell in which two chambers are separated by a membrane, a cathode disposed in one chamber of the cell, an anode disposed in the other chamber of the cell, a cathode recirculating means for recirculating a cathode liquid to said one chamber of the cell and an anode recirculating means for recirculating an anode liquid to the other chamber of the cell, wherein the cathode liquid includes a cathode active material, a first mediator, and a second mediator of which an electric potential that generates a reaction is in contact at least with the first mediator.

### TECHNICAL FIELD

The present invention relates to a redox flow battery.

### BACKGROUND ART

As a storage battery, there is a redox flow battery of which each of an anode and a cathode is provided with a tank storing liquid electrode and which circulates liquid electrode to be supplied to a cell. In PTL 1, a redox flow battery includes a cathode portion, an anode portion, a separator that separates the two portions, and an energy storage unit that contains an electroactive material, electroactive ions, an electrolyte, and a redox mediator. There is disclosed a structure where the storage unit is connected to the cathode portion or the anode portion through a pair of an inlet and an outlet allowing the electrolyte to be circulated to the cathode portion or the anode portion from the energy storage unit.

PTL 2 discloses a structure in which iron ions are used as liquid electrode. PTL 2 discloses a battery that includes a cathode, an anode, a positive compartment that houses a catholyte and the cathode, a negative compartment that houses an anolyte and the anode, and an ionically conductive separation member that separates the positive compartment and the negative compartment, is in contact with both the catholyte and the anolyte, and imparts ionic conductivity between them. The catholyte contains divalent and/or trivalent iron ions and is in contact with the cathode, the anolyte contains divalent iron ions and is in contact with the anode and iron electrodeposited on the anode, and pH of each of the anolyte and the catholyte is within the range of 2 to 12.

### CITATION LIST

### Patent Literature

[PTL 1] PCT Japanese Translation Patent Publication No. 2014-524124

[PTL 2] Japanese Unexamined Patent Application Publication No. 2000-100460

### SUMMARY OF INVENTION

### Technical Problem

In recent years, a redox flow battery that can be more efficiently used for a long period of time has been required.

The invention has been made to solve the above-mentioned problem, and an object of the invention is to provide a redox flow battery that can be more efficiently used for a long period of time.

### Solution to Problem

In order to achieve the above-mentioned object, a redox flow battery according to an aspect of the invention includes a cell that is separated into two chambers by a membrane, a cathode that is disposed in one chamber of the cell, an anode that is disposed in the other chamber of the cell, cathode circulation means for circulating cathode liquid to one chamber of the cell, and anode circulation means for circulating anode liquid to the other chamber of the cell. The cathode liquid contains a cathode active material, a first mediator, and a second mediator of which a potential at which a reaction occurs borders on that of at least the first mediator.

It is preferable that an effective reaction potential difference of the cathode active material is within a range of 3.0 V to 4.3 V.

It is preferable that the cathode active material is NCA, the first mediator is a tetrathiafulvalene derivative, and the second mediator is a quinone derivative.

It is preferable that the cathode liquid is a material of which a solvent has a potential window with respect to the cathode active material.

In order to achieve the above-mentioned object, a redox flow battery according to another aspect of the invention includes a cell that is separated into two chambers by a cation-exchange membrane, a cathode that is disposed in one chamber of the cell, an anode that is disposed in the other chamber of the cell, cathode circulation means for circulating cathode liquid to one chamber of the cell, and anode circulation means for circulating anode liquid to the other chamber of the cell. The anode circulation means includes a circulation passage that is connected to the other chamber of the cell and a tank that is connected to the circulation passage and stores the anode liquid, and the anode liquid contains an anode active material in which iron ionizes and a mediator.

It is preferable that the tank includes a holding mechanism holding a solid of the anode active material in the tank.

It is preferable that, in the anode circulation means, an amount of ionizable iron of the anode active material is larger than a charge/discharge capacity.

It is preferable that, in the anode circulation means, an amount of ionizable iron of the anode active material is equal to a charge/discharge capacity, and charge/discharge is controlled so that an amount of power to be charged is less than the charge/discharge capacity.

It is preferable that, in the anode circulation means, a solvent is liquid in which an iron ion is not dissolved.

In order to achieve the above-mentioned object, a redox flow battery according to still another aspect of the invention includes a cell that is separated into two chambers by a cation-exchange membrane, a cathode that is disposed in one chamber of the cell, an anode that is disposed in the other chamber of the cell, cathode circulation means for circulating cathode liquid to one chamber of the cell, and anode circulation means for circulating anode liquid to the other chamber of the cell. At least one of the cathode circulation means and the anode circulation means uses an active material in which iron ionizes and includes a circulation passage that is connected to the other chamber of the cell, a tank that is connected to the circulation passage and stores the anode liquid, and a treatment device that supplements a precipitate of the active material and ionizes the precipitate.

In order to achieve the above-mentioned object, a redox flow battery according to yet another aspect of the invention includes a cell that is separated into two chambers by a cation-exchange membrane, a cathode that is disposed in one chamber of the cell, an anode that is disposed in the other chamber of the cell, cathode circulation means for circulating cathode liquid to one chamber of the cell, and anode circulation means for circulating anode liquid to the other chamber of the cell. The cathode circulation means uses a cathode active material containing sulfur and includes a circulation passage that is connected to the other chamber of the cell, a tank that is connected to the circulation passage and stores the anode liquid, and a treatment device that supplements a precipitate of the active material and causes the precipitate and the sulfur to react with each other.

### BRIEF DESCRIPTION OF DRAWINGS

FIG. 1 is a schematic diagram showing the schematic configuration of a power system that includes a redox flow battery according to an embodiment of the invention.

FIG. 2 is a graph showing a relationship between a potential and a capacity of a cathode active material.

FIG. 3 is a graph showing a relationship between mediators and an active material.

FIG. 4 is a schematic diagram showing an example of a tank of an anode circulation mechanism.

FIG. 5 is a schematic diagram showing an example of a tank of an anode circulation mechanism.

FIG. 6 is a schematic diagram showing an example of a tank of an anode circulation mechanism.

FIG. 7 is a schematic diagram showing an example of a cathode circulation mechanism.

FIG. 8 is a schematic diagram showing an example of a cathode circulation mechanism.

### DESCRIPTION OF EMBODIMENTS

Embodiments of the invention will be described in detail below with reference to the drawings. The invention is not limited by the embodiments. Components of the following embodiments include components that can be substituted and easily replaced by those skilled in the art or components that are substantially the same as the components of the following embodiments.

### First Embodiment

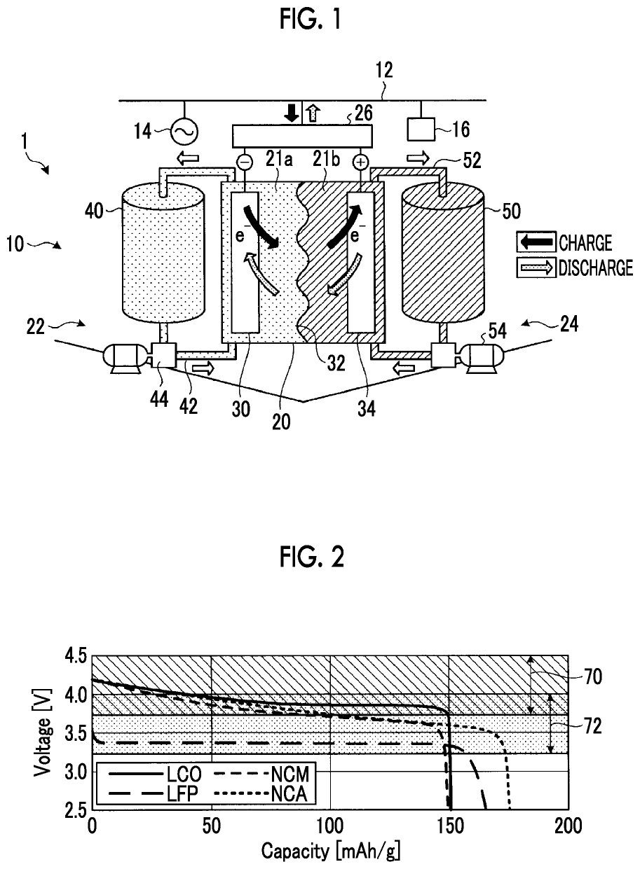

FIG. 1 is a schematic diagram showing the schematic configuration of a power system that includes a redox flow battery according to an embodiment of the invention.

A battery system 1 of this embodiment includes a redox flow battery 10, a system wiring 12, a power generation device 14, and a load device 16. The redox flow battery 10 will be described later. The system wiring 12 connects the redox flow battery 10, the power generation device 14, and the load device 16, and transmits and distributes power. The power generation device 14 is connected to the system wiring 12. The power generation device 14 is a device generating power, and supplies power to the system wiring 12. The load device 16 is connected to the system wiring 12. The load device 16 consumes the power supplied to the system wiring 12.

The redox flow battery 10 is a secondary battery connected to the system wiring 12, and is charged and discharged. The redox flow battery 10 includes a cell 20, an anode circulation mechanism 22, a cathode circulation mechanism 24, and an AC/DC converter 26.

The cell 20 includes an anode 30, a partition wall 32, and a cathode 34. The cell 20 is divided into two chambers in a state where electrons are movable through the partition wall 32. The anode 30 is disposed in one chamber of the cell 20, and the cathode 34 is disposed in the other chamber thereof. Electrolytes (anode liquid and anode liquid) are circulated to the chambers of the cell 20, respectively.

Here, various conductors, such as non-woven fabrics made of graphite, glassy carbon, conductive diamond, and carbon fiber, can be used as the anode 30 and the cathode 34. Further, a porous membrane, a cation-exchange membrane, a solid electrolyte membrane (LiSiCON), and the like can be used as the cornea 32.

The anode circulation mechanism 22 is a mechanism that circulates the anode liquid to the cell 20. The anode circulation mechanism 22 includes a tank 40, a circulation passage 42, and a pump 44. The tank 40 stores the anode liquid. The circulation passage 42 is a passage that allows the anode liquid to be circulated between the tank 40 and a region of the cell 20 in which the anode 30 is disposed. The pump 44 is installed on the circulation passage 42, and circulates the anode liquid in a predetermined direction in a passage of a closed loop that is formed by the circulation passage 42, the tank 40, and the region of the cell 20 in which the anode 30 is disposed.

The cathode circulation mechanism 24 is a mechanism that circulates the cathode liquid to the cell 20. The cathode circulation mechanism 24 includes a tank 50, a circulation passage 52, and a pump 54. The tank 50 stores the cathode liquid. The circulation passage 52 is a passage that allows the cathode liquid to be circulated between the tank 50 and a region of the cell 50 in which the cathode 32 is disposed. The pump 54 is installed on the circulation passage 52, and circulates the cathode liquid in a predetermined direction in a passage of a closed loop that is formed by the circulation passage 52, the tank 50, and the region of the cell 20 in which the cathode 32 is disposed.

The AC/DC converter 26 converts a direct current and an alternating current. The AC/DC converter 26 converts AC power, which is supplied from the system wiring 12, into DC power and supplies the converted DC power to the cell 20. The AC/DC converter 26 converts DC power, which is supplied from the cell 20, into AC power and supplies the converted AC power to the system wiring 12.

The redox flow battery 10 has the above-mentioned configuration. During charge, power supplied from the power generation device 14 is converted into a direct current by the AC/DC converter 26, a current flows in the cathode 34 and the anode 30 disposed in the cell 20, electrons are supplied to the cathode 34 from the cathode liquid, and electrons are supplied to the anode liquid from the anode 30. Accordingly, electric charges are accumulated in the cathode liquid of the redox flow battery 10, so that the redox flow battery 10 is charged.

During discharge, electrons are supplied to the anode 30 from the anode liquid, electrons are supplied to the cathode liquid from the cathode 34, and a direct current is supplied to the AC/DC converter 26 connected to the cathode 34 and the anode 30. The AC/DC converter 26 converts the supplied direct current into an alternating current and supplies the current to the load device 16 through the system wiring 12. Accordingly, the electric charges accumulated in the redox flow battery 10 are released, so that the redox flow battery 10 is discharged.

The redox flow battery 10 can store power by oxidizing and reducing active materials contained in the cathode liquid and the anode liquid. Further, since the redox flow battery 10 includes the tanks, the redox flow battery 10 can store power even in the cathode liquid and the anode liquid stored in the tanks.

Here, in the redox flow battery 10 according to this embodiment, the anode liquid contains NCA (NiCoO₂) as an anode active material and contains a tetrathiafulvalene derivative and a quinone dielectric as mediators (redox mediators). Further, the anode liquid can use acetonitrile (MeCN), tetrahydrofuran (THF), propylene carbonate (PC), and the like as a solvent. The solvent is an organic solvent that has a potential window sufficient for the active material. That is, the solvent is a material of which reactivity is low at a potential where the active material reacts and the reaction does not occur in a range of a potential difference generated during charge and discharge. That is, it is preferable that the cathode liquid is a material of which a solvent has a potential window with respect to a cathode active material. Accordingly, it is possible to suppress generation of an energy loss that is caused by a reaction occurring due to the solvent.

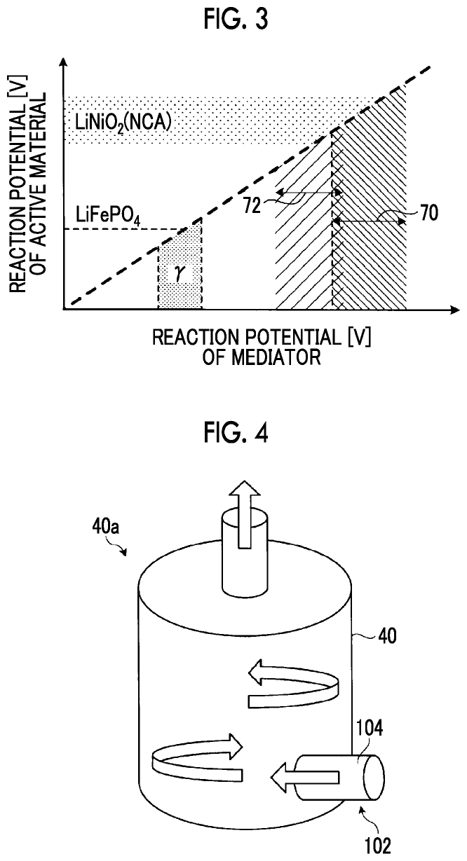

FIG. 2 is a graph showing a relationship between a potential and a capacity of the cathode active material. FIG. 3 is a graph showing a relationship between the mediators and the active material. In FIG. 2, a horizontal axis represents a capacity [mAh/g], and a vertical axis represents a voltage [V]. In FIG. 3, a horizontal axis represents a reaction potential [V] of a mediator, and a vertical axis represents a reaction potential [V] of an active material. As shown in FIGS. 2 and 3, the reaction potential of a tetrathiafulvalene derivative, which is one of two mediators of this embodiment, is in a range 70, and the reaction potential of a quinone dielectric, which is the other thereof, is in a range 72. Further, the reaction potential of NCA (NiCoO₂), which is the cathode active material, is in a range overlapping with both the ranges 70 and 72. Furthermore, the ranges 70 and 72 partially overlap with each other. That is, an upper limit of the reaction potential of the range 70 is higher than an upper limit of the reaction potential of the range 72, and a lower limit thereof is lower than the upper limit of the reaction potential of the range 72.

Since the redox flow battery 10 uses the mediators as in this embodiment, the redox flow battery 10 can cause a reaction between the electrodes and the mediators and a reaction between the mediators and the active materials to occur. Further, since the redox flow battery 10 uses a plurality of mediators of which the reaction potentials are different from each other and partially overlap with each other, the redox flow battery 10 can be charged and discharged at a reaction potential corresponding to the capacity of the active material even though the capacity of power stored in the redox flow battery 10 is charged. Accordingly, since a material having a larger capacity can be used as the cathode active material, energy density of the redox flow battery 10 can be further increased.

Specifically, in a case where LCO (LiFePO₄) is used as an active material as shown in FIG. 3, the reaction potential of the active material can be made to be included in the reaction potential of one mediator y, but there is a limit to capacity. On the other hand, in a case where NCA is used, the reaction potential of the active material is in a range different from the reaction potential of the mediator in the case of one mediator. For this reason, charge and discharge cannot be performed through the mediator. In contrast, since the plurality of mediators are used in this embodiment to make the reaction potential of the active material be included in the ranges of the reaction potentials of the plurality of mediators, charge and discharge can be performed even though the capacity of power charged in the active material is changed. Accordingly, since an active material having a large capacity but having a variable reaction potential can be used as the active material, energy density can be further increased. Further, since a reaction potential difference at each potential is increased in a case where a mediator having a wide range of a reaction potential is used, an energy loss is increased. However, since the plurality of mediators are used, it is possible to reduce a potential difference in a case where a reaction occurs. Accordingly, it is possible to efficiently advance the redox reactions of the respective mediators.

Here, in the above-mentioned embodiment, NCA has been used as the active material of the cathode liquid, but NCM, LCO, 213 series, and the like can also be used. It is preferable that the effective reaction potential difference of an electrode active material is within a range of 3.0 V to 5.0 V. The effective reaction potential difference is a potential difference that is generated in a case where a battery is charged up to a target capacity, and has a different value depending on the material. For example, the effective reaction potential difference of NCA is a reaction potential difference that is generated in a case where a battery is charged up to 180 mAh/g. Accordingly, a capacity can be increased. Further, in a case where the plurality of mediators are combined so that the ranges of the reaction potentials partially overlap with or border on the reaction potentials of the mediators, the plurality of mediators can suitably react at each capacity. The mediators are not limited to two types of mediators and may be three or more types of mediators.

Here, it is preferable that the plurality of mediators are combined so that the ranges of the reaction potentials border on the reaction potentials of the mediators. Accordingly, since the number of mediators reacting at each potential can be set to one, a reaction can be stabilized.

### Second Embodiment

The device configuration of a second embodiment is the same as that of the first embodiment, but a material in which iron ionizes, an inorganic salt, and a metal complex of iron including organic ligands are used as an active material of anode liquid. In this case, the anode liquid contains a mediator and uses a solvent in which Fe2⁺ does not dissolve as a solvent. Further, the active material is held in the tank 40.

Since the mediator is used in the anode liquid as described above, the anode and the mediator are made to react with each other, and a reaction can be made to occur between the mediator and the active material. Accordingly, since it is possible to suppress the reaction of the active material in a vicinity of the anode, it is possible to suppress precipitation of the active material on the electrode. Further, since a solvent in which iron ions do not precipitate is used as the solvent, it is possible to suppress the movement of the active material to the vicinity of the anode that is caused by the circulation of the anode liquid.

Accordingly, since the reaction of iron of the active material can be completed in the tank 40, the formation of dendrite-like metal on the anode can be suppressed. Further, an internal short circuit and a reduction in capacity, which are caused by the formation of dendrite on the electrode, can be prevented. Furthermore, it is possible to prevent the formation of dendrite while using iron as the active material.

Here, in a case where the active material is held in the tank 40 as in the second embodiment, it is preferable that the tank 40 is provided with an active material holding mechanism. FIGS. 4 to 6 are schematic diagrams showing examples of tanks of anode circulation mechanisms, respectively.

A tank 40a shown in FIG. 4 includes an active material holding mechanism 102. The active material holding mechanism 102 is a pipe 104 of a part of a circulation passage that supplies circulating liquid to the tank. The pipe 104 is disposed on a side surface of the tank 40a. Since the pipe 104 is disposed on the side surface, the active material holding mechanism 102 forms a flow swirling in the tank 40a and holds a solid active material on an outer peripheral side of the tank 40a via the swirling flow. Accordingly, an inflow of the active material into the circulation passage 42 from the tank 40a is suppressed. Further, the tank 40a is provided with a pipe through which the anode liquid flowing toward the cell 20 is discharged and which is disposed at the center of an upper end of the tank 40a. Accordingly, the active material held on the outer peripheral side of the tank 40a can be more difficult to be discharged.

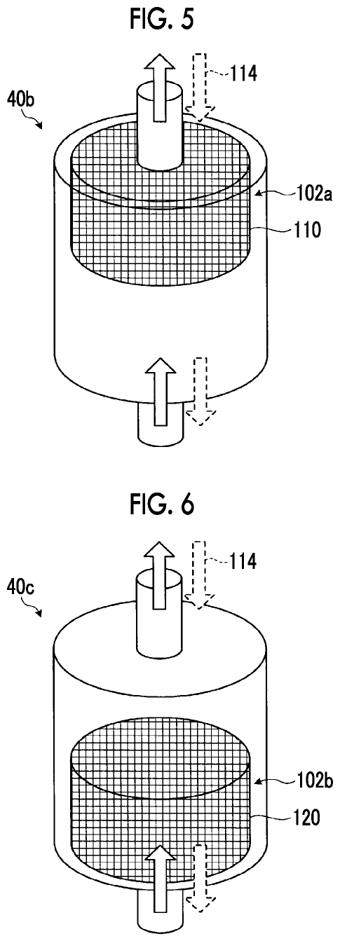

A tank 40b shown in FIG. 5 includes an active material holding mechanism 102a. The active material holding mechanism 102a includes a filter 110. The filter 110 is disposed so as to block a pipe of the tank 40b that is provided on a downstream side of a flow direction of the anode liquid. The filter 110 is a mesh or a membrane, is a structure having gaps smaller than the active material, allows the solvent and the mediator to pass through, and collects the active material. Accordingly, the active material moving toward the cell 20 from the tank 40b can be collected by the filter 110. Further, it is preferable that the anode circulation mechanism 22 causes the anode liquid to flow in a reverse direction as shown by an arrow 114 to backwash the filter and to suppress clogging.

A tank 40c shown in FIG. 6 includes an active material holding mechanism 102b. The active material holding mechanism 102b includes a magnet 120. The magnet 120 supplements the active material held in the tank 40c. Accordingly, the active material held in the tank 40c can be collected by the magnet 120. Further, an electromagnet may be used as the magnet 120. The anode circulation mechanism 22 may cancel the magnetization of the magnet 120 and cause the anode liquid to flow in a reverse direction as shown by an arrow 114 to remove the active material adsorbed on the magnet 120 once and to cause the active material to be adsorbed on the magnet 120 again.

Since the active material holding mechanisms 102, 102a, and 102b are provided as shown in FIGS. 4 to 6, it is possible to suppress the inflow of the active material into the cell 20. Accordingly, it is possible to suppress the formation of dendrite, wear caused by contact between the active material and the membrane, wear caused by contact between the active material and the electrode, and the like.

Further, it is preferable that the amount of the active material contained in the anode liquid is larger than the charge/discharge capacity of the battery in the redox flow battery according to the second embodiment. That is, it is preferable that the active material is contained in the anode liquid so that Fe not changed into Fe2⁺ is present even at the time of complete discharge. Accordingly, in a case where the active material is held by, for example, the magnet, the active material can be held on the magnet even at the time of complete discharge.

Further, the redox flow battery may be discharged in a range where the active material contained in the anode liquid can maintain the state of Fe, that is, may control the SOC of the battery. Accordingly, in a case where the active material is held by the magnet, the active material can be held on the magnet.

### Third Embodiment

Furthermore, a solvent in which iron ions do not dissolve has been used as the solvent in the second embodiment, but a solvent in which iron ions dissolve may be used. A redox flow battery according to a third embodiment uses a material in which iron ionizes, an inorganic salt, and a metal complex of iron including organic ligands as an active material of anode liquid. Further, the anode liquid contains a mediator and uses a solvent in which Fe2⁺ dissolves as a solvent.

Since the anode liquid contains a mediator even in a case where a solvent in which Fe2⁺ dissolves is used as the solvent as described above, the active material flowing into the tank and not conducting electricity to the anode, for example, dendrite delaminated from the electrode, also reacts with the mediator and can be ionized. Accordingly, a reduction in the capacity of the battery can be suppressed.

### Fourth Embodiment

A redox flow battery according to a fourth embodiment uses a material in which iron ionizes, an inorganic salt, and a metal complex of iron including organic ligands as active materials of cathode liquid and anode liquid. A case where a material in which iron ionizes, an inorganic salt, and a metal complex of iron including organic ligands are used in the cathode liquid as the active material will be described below, but the same applies to an anode side. Further, the cathode liquid may contain a mediator or may not contain a mediator.

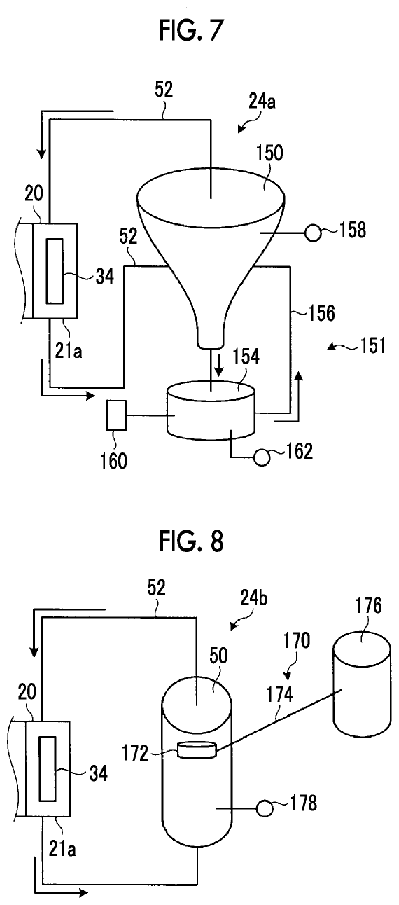

FIG. 7 is a schematic diagram showing an example of a cathode circulation mechanism. The redox flow battery shown in FIG. 7 includes a cathode circulation mechanism 24a. The cathode circulation mechanism 24a includes a tank 150, a circulation passage 52, and a precipitate treatment unit 151. The cathode circulation mechanism 24a also includes a pump. The tank 150 is connected to the circulation passage 52. A lower portion of the tank 150 has the shape of a funnel of which the cross-sectional area is reduced toward a bottom portion. In a case where precipitates present in the tank 150 are deposited, the precipitates are accumulated at the funnel-shaped lower portion. It is preferable that the lower portion of the tank 150 is provided with a transparent portion so that a deposition state of the precipitates can be detected.

The precipitate treatment unit 151 includes a reaction tank 154, a circulation passage 156, charging rate detection units 158 and 162, and a reactant feeding unit 160. The reaction tank 154 stores the cathode liquid that is supplied from the tank 150 and contains the precipitates. The circulation passage 156 is a passage that allows the cathode liquid to be circulated between the tank 150 and the reaction tank 154. The cathode liquid is supplied to the precipitate treatment unit 151 from a lower end of the tank 150, and the precipitate treatment unit 151 returns the cathode liquid, which is treated by the reaction tank 154, to the tank 150. The charging rate detection unit 158 is installed on the tank 150, and analyzes the components of the cathode liquid stored in the tank 150 to detect a charging rate. An EDTA titrimetric analyzer, an absorptiometric analyzer, and the like can be used as the charging rate detection unit 158. The reactant feeding unit 160 feeds a material that regenerates the precipitates of the cathode liquid. A pH adjuster or a chelating agent is exemplified as a reactant. The charging rate detection unit 162 is installed on the reaction tank 154, and analyzes the components of the cathode liquid stored in the tank 150 to detect a charging rate. An EDTA titrimetric analyzer, an absorptiometric analyzer, and the like can be used as the charging rate detection unit 162.

The precipitate treatment unit 151 collects the precipitates, which are generated in the tank 150, in the reaction tank 154 and performs regeneration treatment. Further, the amount of reactant to be fed and the amount of cathode liquid to be supplied to the reaction tank 154 may be determined on the basis of the detection results of the charging rate detection materials 158 and 162 and the confirmation result of the amount of the precipitates.

Since the cathode circulation mechanism 24a includes the precipitate treatment unit 151 as described above, the cathode circulation mechanism 24a can regenerate an insoluble product generated in the tank, can maintain the performance of the cathode liquid, and can suppress a reduction in the energy density of charging. Further, since a reaction in the reaction tank 154 is controlled on the basis of the detection results of the charging rate detection units 158 and 162 and the confirmation result of the amount of the precipitates, it is possible to more appropriately maintain the state of the cathode liquid and to regenerate a cathode material while reducing an influence on the charge and discharge of the redox flow battery.

FIG. 8 is a schematic diagram showing an example of a cathode circulation mechanism. The redox flow battery shown in FIG. 8 includes a cathode circulation mechanism 24b. The cathode circulation mechanism 24b includes a tank 50, a circulation passage 52, and a precipitate treatment unit 170. The cathode circulation mechanism 24b also includes a pump.

The precipitate treatment unit 170 includes a precipitate collecting unit 172, a flow channel 174, a reaction tank 176, and a charging rate detection unit 178. The precipitate collecting unit 172 is disposed in the tank 50 and collects the precipitates present in the tank 50. The precipitate collecting unit 172 includes a magnet, a filter, or the like and collects precipitates floating in the tank 50. The flow channel 174 connects the precipitate collecting unit 172 to the reaction tank 176, supplies cathode liquid, which is subjected to the precipitate collecting unit 172, to the reaction tank 176, and supplies cathode liquid, which is treated by the reaction tank 176, to the tank 50. The flow channel 174 is a mechanism that can adjust a direction in which liquid is supplied and the amount of liquid to be supplied. The reaction tank 176 stores the cathode liquid that is supplied from the tank 50 and contains the precipitates. The reaction tank 176 performs regeneration treatment for regenerating the precipitates that are contained in the supplied cathode liquid. The charging rate detection unit 178 is installed on the tank 50, and analyzes the components of the cathode liquid stored in the tank 50 to detect a charging rate. An EDTA titrimetric analyzer, an absorptiometric analyzer, and the like can be used as the charging rate detection unit 178.

The precipitate treatment unit 170 supplies the cathode liquid to the reaction tank 176 together with the precipitates collected by the precipitate repairing unit 172 disposed in the tank 50, and performs regeneration treatment via the reaction tank 176. The precipitate treatment unit 151 returns the cathode liquid, which is regenerated by the reaction tank 176, to the tank 50 through the flow channel 174. The amount of reactant to be fed and the amount of cathode liquid to be supplied to the reaction tank 176 may be determined on the basis of the detection result of the charging rate detection materials 158 and 162 and the confirmation result of the amount of the precipitates.

Since the cathode circulation mechanism 24b includes the precipitate treatment unit 170 as described above, the cathode circulation mechanism 24b can regenerate an insoluble product floating in the tank 50, can maintain the performance of the cathode liquid, and can suppress a reduction in the energy density of charging. Further, since a reaction in the reaction tank 176 is controlled on the basis of the detection result of the charging rate detection unit 178 and the confirmation result of the amount of the precipitates, it is possible to more appropriately maintain the state of the cathode liquid and to regenerate a cathode material while reducing an influence on the charge and discharge of the redox flow battery. Furthermore, the cathode circulation mechanism may include both the precipitate treatment units 151 and 170.

### Fifth Embodiment

The redox flow battery according to the fourth embodiment is a case where a material in which iron ionizes, an inorganic salt, and a metal complex of iron including organic ligands are used as the active materials of the cathode liquid and the anode liquid. In contrast, a redox flow battery according to a fifth embodiment is a case where a sulfur (S)-based material is used for a cathode and a material in which lithium ionizes, an inorganic salt, and a metal complex including organic ligands are used as a cathode material. The material of anode liquid is not particularly limited. Further, the cathode liquid may contain a mediator or may not contain a mediator.

Even in a case where a material containing sulfur is used for the cathode as in the fifth embodiment, it is preferable that the precipitate treatment units 151 and 170 are provided as shown in FIGS. 7 and 8 described above. In this case, in the reaction tanks 154 and 170, Li₂S_{X} (2<X≤8) having high solubility is obtained from reaction between Li₂S as a precipitate and S₈ as a reactant. Li₂S_{X} is returned to the original tank.

Since the cathode circulation mechanism 24a includes the precipitate treatment unit 151 even in a case where a material containing sulfur is used for the cathode as described above, the cathode circulation mechanism 24a can regenerate an insoluble product generated in the tank, can maintain the performance of the cathode liquid, and can suppress a reduction in the energy density of charging. Further, since a reaction in the reaction tank 154 is controlled on the basis of the detection results of the charging rate detection units 158 and 162 and the confirmation result of the amount of the precipitates, it is possible to more appropriately maintain the state of the cathode liquid and to regenerate a cathode material while reducing an influence on the charge and discharge of the redox flow battery. Furthermore, the cathode circulation mechanism may include both the precipitate treatment units 151 and 170.

### REFERENCE SIGNS LIST

1: power system
10: redox flow battery
12: system wiring
14: power generation device
16: load device
20: cell
22: anode circulation mechanism
24: cathode circulation mechanism
26: AC/DC converter
30: anode
32: membrane
34: cathode
40, 50: tank
42, 52: circulation passage
44, 54: pump

1. A redox flow battery comprising:
a cell that is separated into two chambers by a membrane;
a cathode that is disposed in one chamber of the cell;
an anode that is disposed in the other chamber of the cell;
cathode circulation means for circulating cathode liquid to one chamber of the cell; and
anode circulation means for circulating anode liquid to the other chamber of the cell,
wherein the cathode liquid contains a cathode active material, a first mediator, and a second mediator of which a potential at which a reaction occurs borders on that of at least the first mediator.

2. The redox flow battery according to claim 1,
wherein an effective reaction potential difference of the cathode active material is within a range of 3.0 V to 4.3 V.

3. The redox flow battery according to claim 1,
wherein the cathode active material is NCA,
the first mediator is a tetrathiafulvalene derivative, and
the second mediator is a quinone derivative.

4. The redox flow battery according to claim 1,
wherein the cathode liquid is a material of which a solvent has a potential window with respect to the cathode active material.

5. A redox flow battery comprising:
a cell that is separated into two chambers by a cation-exchange membrane;
a cathode that is disposed in one chamber of the cell;
an anode that is disposed in the other chamber of the cell;
cathode circulation means for circulating cathode liquid to one chamber of the cell; and
anode circulation means for circulating anode liquid to the other chamber of the cell,
wherein the anode circulation means includes a circulation passage that is connected to the other chamber of the cell and a tank that is connected to the circulation passage and stores the anode liquid, and
the anode liquid contains an anode active material in which iron ionizes and a mediator.

6. The redox flow battery according to claim 5,
wherein the tank includes a holding mechanism that holds a solid of the anode active material in the tank.

7. The redox flow battery according to claim 5,
wherein in the anode circulation means, an amount of ionizable iron of the anode active material is larger than a charge/discharge capacity.

8. The redox flow battery according to claim 5,
wherein in the anode circulation means, an amount of ionizable iron of the anode active material is equal to a charge/discharge capacity, and
charge/discharge is controlled so that an amount of power to be charged is less than the charge/discharge capacity.

9. The redox flow battery according to claim 5,
wherein in the anode circulation means, a solvent is liquid in which an iron ion is not dissolved.

10. A redox flow battery comprising:
a cell that is separated into two chambers by a cation-exchange membrane;
a cathode that is disposed in one chamber of the cell;
an anode that is disposed in the other chamber of the cell;
cathode circulation means for circulating cathode liquid to one chamber of the cell; and
anode circulation means for circulating anode liquid to the other chamber of the cell,
wherein at least one of the cathode circulation means and the anode circulation means uses an active material in which iron ionizes and includes a circulation passage that is connected to the other chamber of the cell, a tank that is connected to the circulation passage and stores the anode liquid, and a treatment device that collects a precipitate of the active material and ionizes the precipitate.

11. A redox flow battery comprising:
a cell that is separated into two chambers by a cation-exchange membrane;
a cathode that is disposed in one chamber of the cell;
an anode that is disposed in the other chamber of the cell;
cathode circulation means for circulating cathode liquid to one chamber of the cell; and
anode circulation means for circulating anode liquid to the other chamber of the cell,
wherein the cathode circulation means uses a cathode active material containing sulfur and includes a circulation passage that is connected to the other chamber of the cell, a tank that is connected to the circulation passage and stores the anode liquid, and a treatment device that collects a precipitate of the active material and causes the precipitate and the sulfur to react with each other.
